(19) United States
(12) Patent Application Publication
(10) Pub. No.: US 2026/0292085 A1
(43) Pub. Date: Sep. 24, 2026

(54) IMAGE READING DEVICE AND IMAGE FORMING APPARATUS

(71) Applicants: Ayumu HASHIMOTO, Kanagawa (JP); Shogo NAKAMURA, Kanagawa (JP)

(72) Inventors: Ayumu HASHIMOTO, Kanagawa (JP); Shogo NAKAMURA, Kanagawa (JP)

(73) Assignee: Ricoh Company, Ltd., Ohta-ku, Tokyo (JP)

(21) Appl. No.: 19/479,928

(22) PCT Filed: May 23, 2024
(86) PCT No.: PCT/JP2024/018977

§ 371 Date: Oct. 29, 2025

(30) Foreign Application Priority Data
Jun. 7, 2023 (JP) 2023-094220

(51) Int. Cl. H04N 1/00

(52) U.S. Cl. CPC H04N 1/0066; H04N 1/00379; H04N 1/00588; H04N 1/00663; H04N 1/00718

(57) ABSTRACT

An image reading device includes a document tray, a wall surface, a conveyance unit, an image reading unit, and a position indication member. The document tray has a document placement surface on which one or more documents are placed. The documents placed on the document tray are made to abut on the wall surface. The conveyance unit is configured to convey the documents one by one. The image reading unit is configured to read images of the documents conveyed by the conveyance unit. The position indication member is arranged on the wall surface and has scale marks indicating a position in which the documents are to be set on the document placement surface.

### TECHNICAL FIELD

The present invention relates to an image reading device and an image forming apparatus.

### BACKGROUND ART

A technique enabling successive scans of documents in a plurality of width sizes, such as a standard size and irregular sizes that are placed in a mixed manner using an ADF (Auto Document Feeder) has been known. In order to successively convey the documents in the width sizes that are placed in a mixed manner as described above, it is necessary to set the documents in the width sizes placed in a mixed manner appropriately with respect to a position in which the documents are picked up.

A technique in which a plurality of position indicators are included in a center position on an upper part of an ADF and a position symmetric to the center position in order to indicate an appropriate setting position of documents in a plurality of width sizes that are placed in a mixed manner is disclosed in Patent Literature 1.

### SUMMARY OF INVENTION

### Technical Problem

According to the conventional technique, however, because there is a gap in height corresponding to the number of documents that can be loaded between the position of the position indicators indicating the setting position on the upper part of the ADF and a placement surface on which documents are placed actually, there has been a problem that it is difficult to check by sight the relationship between the position of the position indicators and the position of the end of the documents and thus it is difficult to set documents in a plurality of width sizes that are placed in a mixed manner or a shift after setting of documents in a plurality of width sizes that are placed in a mixed manner occurs.

An object of the preset invention is to make it possible to accurately set documents in a plurality of width sizes that are placed in a mixed manner.

### Solution to Problem

In order to solve the above problem and achieve the object, an image reading device according to an aspect of the present invention includes a document tray, a wall surface, a conveyance unit, an image reading unit, and a position indication member. The document tray has a document placement surface on which one or more documents are placed. The documents placed on the document tray are made to abut on the wall surface. The conveyance unit is configured to convey the documents one by one. The image reading unit is configured to read images of the documents conveyed by the conveyance unit. The position indication member is arranged on the wall surface and has scale marks indicating a position in which the documents are to be set on the document placement surface.

### Advantageous Effects of Invention

According to an aspect of the present invention, an effect that it is possible to enable accurate setting of documents in a plurality of width sizes that are placed in a mixed manner is brought about.

### BRIEF DESCRIPTION OF DRAWINGS

FIG. 1 is a schematic configuration diagram of an image forming apparatus according to a first embodiment.

FIG. 2 is an illustration illustrating an example of a configuration near a document tray of an ADF.

FIG. 3 is a block diagram illustrating a main configuration of the image forming apparatus.

FIG. 4 is a diagram illustrating a problem in a conventional ADF.

FIG. 5A is a diagram illustrating an effect of indication of a setting position by a position indication member.

FIG. 5B is a diagram illustrating an effect of indication of a setting position by a position indication member.

FIG. 6A is a diagram illustrating a modification of the position indication member.

FIG. 6B is a diagram illustrating a modification of the position indication member.

FIG. 7 is a block diagram illustrating a functional configuration of an image processing unit that an image forming apparatus according to a second embodiment includes.

FIG. 8A is a diagram illustrating a relationship between widths between scale marks and a skew in a position indication member.

FIG. 8B is a diagram illustrating a relationship between widths between scale marks and a skew in a position indication member.

FIG. 8C is a diagram illustrating a relationship between widths between scale marks and a skew in a position indication member.

### DESCRIPTION OF EMBODIMENTS

Embodiments of an image reading device and an image forming apparatus will be described in detail below with reference to the accompanying drawings.

### First Embodiment

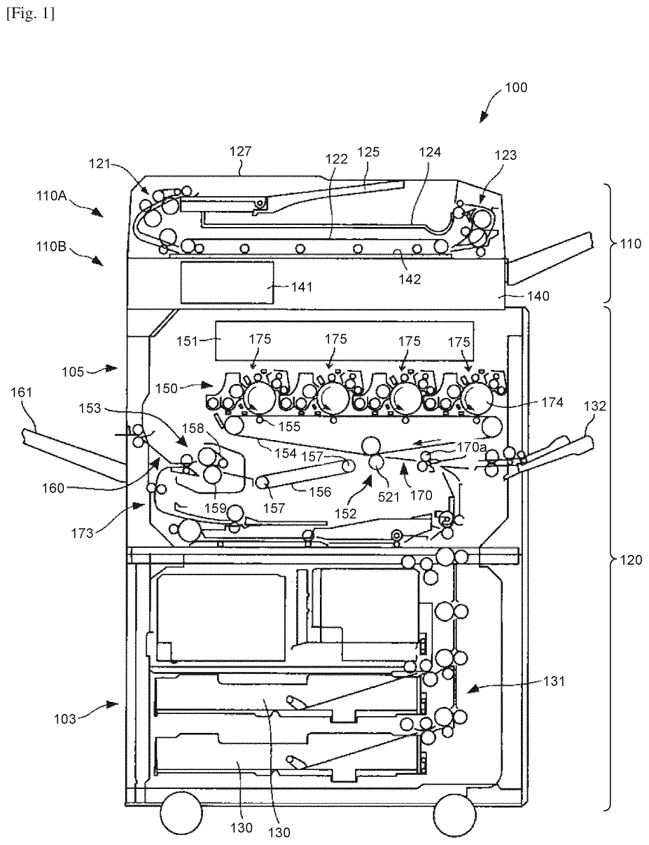

FIG. 1 is a schematic configuration diagram of an image forming apparatus 100 according to a first embodiment. FIG. 1 illustrates, as an example, the image forming apparatus 100 that has at least two of a copy function, a printer function, a scanner function, and a facsimile function and that is generally referred to as an MFP (Multifunction Peripheral/Printer/Product). As illustrated in FIG. 1, the image forming apparatus 100 roughly includes a scanner 110 that is an image reading device and a plotter 120. The scanner 110 includes an ADF (Auto Document Feeder) 110A and an image reading unit 110B. The plotter 120 includes a paper feeding unit 103 and an image forming unit 105.

The ADF 110A is configured by including a document tray 125, document feeding rollers 121 configuring a conveyance unit, a document conveyance belt 122, a document ejection roller 123, and a document ejection tray 124. The ADF 110A is attached to the image reading unit 110B via an open-close mechanism (not illustrated in the drawing), such as a hinge, such that the ADF 110A is openable. A or a plurality of documents that should be scanned are placed or are loaded on the document tray 125. In other words, an upper surface of the document tray 125 serves as an “document placement surface”.

The document feeding rollers 121 separate the documents one by one from the bundle of the documents that are placed on the document tray 125 and that are made about on a wall surface 128 and conveys the document toward the image reading unit 110B. The document conveyance belt 122 conveys the document that is separated from the document feeding rollers 121 to the image reading unit 110B. The document ejection roller 123 ejects the document that is ejected from the image reading unit 110B by the document conveyance belt 122 to the document ejection tray 124 under the document tray 125.

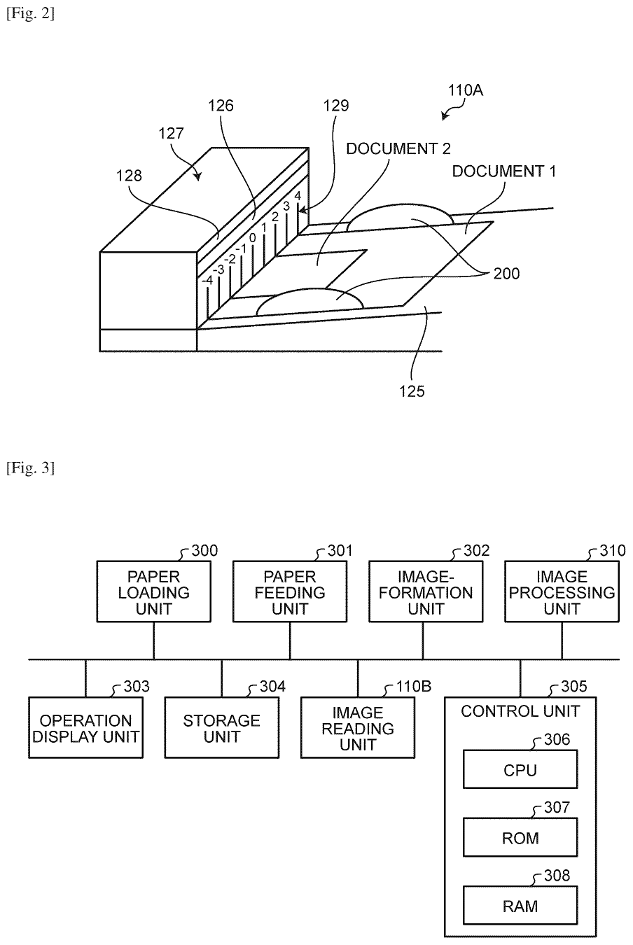

The document tray 125 lifts up toward a paper feeding opening 126 (refer to FIG. 2) after a user sets the documents, so that the documents that are placed on the document tray 125 enter into a state of being to be fed.

The image reading unit 110B is configured by including a casing 140, a scanning optical unit 141, a contact glass 142, and a drive unit (not illustrated in the drawings). The scanning optical unit 141 is arranged inside the casing 140 and includes an LED unit. The scanning optical unit 141 emits light from the LED unit in a main-scanning direction and is caused to perform scanning in a sub-scanning direction on an entire irradiation area. Accordingly, the scanning optical unit 141 reads a two-dimensional color image of the document.

The contact glass 142 is arranged on the top of the casing 140 of the image reading unit 110B and configures a top surface part of the casing 140. The drive unit includes a wire that is fixed to the scanning optical unit 141 and that is not illustrated in the drawings, a plurality of driven pulleys (not illustrated in the drawings) and a driving pulley (not illustrated in the drawings) that the wire bridges, and a motor that causes the driving pulley to rotate.

The paper feeding unit 103 includes a paper feeding cassette 130 and a paper feeding unit 131. The paper feeding cassette 130 houses paper sheets (not illustrated in the drawings) serving as recording media in different paper sizes. The paper feeding unit 131 conveys the paper sheets that are housed in the paper feeding cassette 130 to a main conveyance path 170 of the image forming unit 105.

A manual paper feeding unit tray 132 is arranged on a side surface of the image forming unit 105 such that the manual paper feeding unit tray 132 is openable to the image forming unit 105 and a paper bundle is manually fed to a tray upper surface with the manual paper feeding unit tray 132 being open to the image forming unit 105. The top paper sheet of the paper bundle that is fed manually is sent out toward the main conveyance path 170 by a sending-out roller of the manual paper feeding unit tray 132.

A registration roller pair 170a is arranged on the main conveyance path 170. After interposing a paper sheet conveyed through the main conveyance path 170 between the rollers, the registration roller pair 170a sends out the paper sheet at given timing toward a secondary transfer nip.

The image forming unit 105 includes an exposure unit 151, a tandem image-formation unit 150, an intermediate transfer belt 154, an intermediate transfer roller 155, a secondary transfer device 152, and a fixing unit 153. The image forming unit 105 includes the main conveyance path 170, an inversion conveyance path 173, and a paper-ejection path 160.

As illustrated in FIG. 1, the exposure unit 151 is arranged adjacently to the tandem image-formation unit 150. The exposure unit 151 exposes photoconductor drums 174 that are arranged correspondingly to yellow, cyan, magenta, and black, respectively, with light.

The tandem image-formation unit 150 is above the intermediate transfer belt 154 and consists of four image-formation units 175 of yellow, cyan, magenta, and black that are arranged along a direction in which the intermediate transfer belt 154 rotates. Although detailed illustration is omitted, each of the image-formation units 175 includes a charging device, a developing device, a photoconductor cleaning device, and a neutralization device around the photoconductor drum 174 that is arranged correspondingly to each color. Each of the photoconductor drums 174 and each of the above-described devices that are arranged around the photoconductor drum 174 are unitized, thereby configuring one process cartridge.

Based on image information that is read by the image reading unit 110B and on which separation by color is performed, the tandem image formation unit 150 forms visible images (toner images) that are formed using toner separately in color on the respective photoconductor drums 174. The visible images that are formed on the respective photoconductor drums 174 are transferred onto the intermediate transfer belt 154 between each of the photoconductor drums 174 and the intermediate transfer roller 155.

On the other hand, the secondary transfer device 152 is arranged on the side opposite to the tandem image-formation unit 150 with the intermediate transfer belt 154 in between. The secondary transfer device 152 includes a secondary transfer roller 521 serving as a transfer member. The secondary transfer roller 521 is pressed against the intermediate transfer belt 154, thereby forming a secondary transfer nip. The secondary transfer nip is formed such that the toner images that are formed on the intermediate transfer belt 154 are transferred onto the paper sheet that is conveyed from the paper feeding unit 103 via the main conveyance path 170.

The paper sheet onto which the toner images are transferred in the secondary transfer nip is sent out by a paper conveyance belt 156 that is stretched to two support rollers 157 to the fixing unit 153.

The fixing unit 153 is configured with a pressure roller 159 being pressed against a fixing belt 158 that is an endless belt. The fixing unit 153 applies heat and pressure to the paper sheet with the pressure roller 159, thereby melting the toner of the toner images transferred to the paper sheet and fixing the toner images as a color image.

The paper sheet on which the color image is fixed in this manner is stacked on a paper ejection tray 161 outside the apparatus via the paper ejection path 160 serving as a paper ejection conveyance path.

As illustrated in FIG. 1, the inversion conveyance path 173 is arranged under the secondary transfer device 152 and the fixing unit 153. The inversion conveyance path 173 is for, in order to form images on both surfaces of the paper sheet, inverting the front and back of the paper sheet that is ejected from the fixing unit 153 and supplying the paper sheet to the secondary transfer device 152 again via the main conveyance path 170.

A plurality of conveyance sensing sensors (not illustrated in the drawings) serving as a paper jam sensing unit are arranged along the conveyance path on the main conveyance path 170 and the inversion conveyance path 173. The number of and the spots of arrangement of the conveyance sensing sensors are set as appropriate. When each of the conveyance sensing sensors does not sense passing of a paper sheet within each predetermined time, the sensor senses that a jam of the paper sheet (non-conveyance or a paper jam) has occurred and notifies a display unit (not illustrated in the drawings) of the image forming apparatus 100 of the occurrence of the jam.

An example of a configuration near the document tray 125 of the ADF 110A will be described in detail next.

FIG. 2 is an illustration illustrating the example of the configuration near the document tray 125 of the ADF 110A. As illustrated in FIG. 1, the image forming apparatus 100 includes the ADF 110A above a main unit. Side fences 200 in a pair are set on the document tray 125 of the ADF 110A.

The side fences 200 are configured such that the side fences 200 are movable in the main-scanning (width) direction of a document and guides both ends of the document in the width direction. Mounting a main-scanning length sensing sensor using a known variable resistor whose output changes successively in association with shifts of the side fences 200, or the like, on the side fences 200 also enables a function of sensing a length of the document in the main-scanning direction. In this case, because of detection of the positions of the side fences 200 in a state in which the side fences 200 are aligned with both ends of the document, the length of the document in the main-scanning direction is sensed.

The ADF 110A includes an open-close cover 127 including the paper feeding opening 126 via which the documents placed on the document tray 125 are fed. The document feeding rollers 121 consisting of the group of rollers and a group of gears for conveying the documents on the document tray 125 are arranged inside the open-close cover 127. The open-close cover 127 is a cover that is arranged such that the open-close cover 127 is openable to hide or expose a downstream end of the document tray 125 and the document feeding rollers 121. Note that, in the present embodiment, the document feeding rollers 121 are arranged in a position communicating with approximately the center of the document tray 125.

In addition, in the ADF 110A, a position indication member 129 having scale marks indicating an appropriate setting position of documents is arranged on the wall surface 128 having the paper feeding opening 126 of the open-close cover 127. The position indication member 129 has scale marks indicating a center position of the document tray 125 and positions symmetric to the center position. The position indication member 129 is printed on the wall surface 128 of the open-close cover 127. Note that the position indication member 129 may be a sheet in a form of a sticker and be adhered to the wall surface 128 of the open-close cover 127. The position indication member 129 is not limited to printing on the wall surface 128 of the open-close cover 127 or being a sheet in a form of a sticker and being adhered, and the position indication member 129 may be configured to indicate a center position and a combination of right and left symmetric positions in the width direction about a center reference by emitting light at given intervals to a document using a light emitter, such as an LED, or changing the color of light.

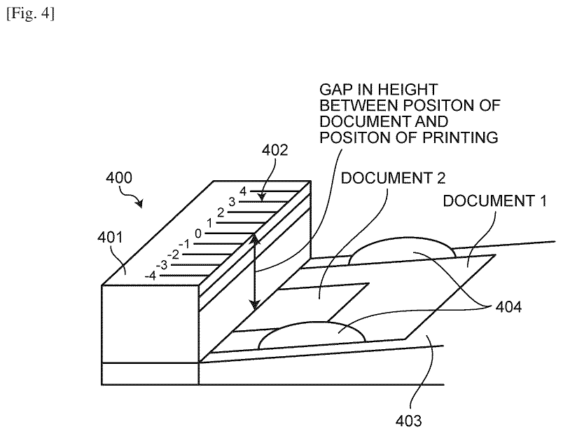

FIG. 3 is a block diagram illustrating a main configuration of the image forming apparatus 100. The image forming apparatus 100 includes a paper loading unit 300, a paper feeding unit 301, an image-formation unit 302, an operation display unit 303, a storage unit 304, a control unit 305, an image processing unit 310, and an image reading unit 110B.

As for the paper loading unit 300, paper sheets to be fed are loaded on the paper feeding cassette 130 or the manual paper feeding unit tray 132. As illustrated in FIG. 1, the paper feeding unit 301 includes the paper feeding unit 103, includes the paper feeding cassette 130, the paper feeding unit 131, and the manual paper feeding unit tray 132, and feeds and conveys the paper sheet to the main conveyance path 170. The image-formation unit 302 corresponds to the image forming unit 105, performs formation of an image based on an image-formation process, and transfers the image onto the fed and conveyed paper sheet.

The operation display unit 303 includes various types of operation keys, a display, for example, a liquid crystal display, and a lamp, such as an LED. The operation keys are used to input operations necessary to use each of functions of copying, printing, and scanning by the image forming apparatus 100 and an operation of specifying a paper type. The content of commands that are input from the operation keys and various types of information of which the user is notified by the image forming apparatus 100 are displayed on the display.

The storage unit 304 is configured using, for example, a HDD (hard disk drive), a ROM, or a RAM.

The control unit 305 includes a CPU (Central Processing Unit) 306, a ROM (Read Only Memory) 307, and a RAM (Random Access Memory) 308.

The CPU 306 controls the entire image forming apparatus 100. A program that the CPU 306 executes is stored in the ROM 307 and the CPU 306 reads the program from the ROM 307 and executes the program. The RAM 308 is used as a working memory when the CPU 306 performs the control.

The image processing unit 310 performs given image processing on a read image that is read by the image reading unit 110B.

A problem in the conventional ADF will be described here.

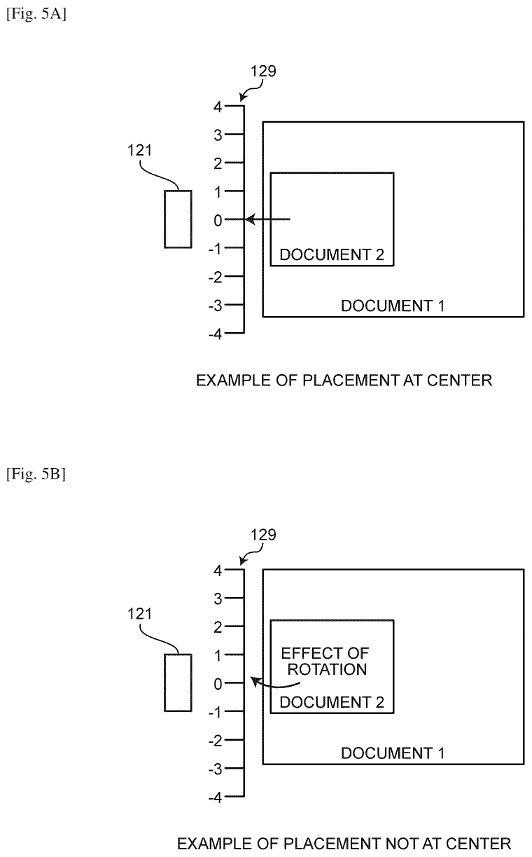

FIG. 4 is a diagram illustrating the problem in the conventional ADF. As illustrated in FIG. 4, the conventional ADF 400 includes a position indicator 402 indicating a center position and positions symmetrical about the center position on an upper part of an open-close cover 401 for the purpose of indicating an appropriate position in which documents are placed and a direction of placement. Using the position indicator 402 makes it possible to induce appropriate setting of the center of documents or both ends of the documents.

In the conventional ADF 400, however, there is a gap in height corresponding to the number of documents that can be loaded between the position of the position indicator 402 on an upper part of the open-close cover 401 and a document tray 403 on which documents are placed actually. Practically, the user who sets documents stands in front of the image forming apparatus and sets documents and thus has a point of view of looking down obliquely from the front side of the ADF 400 to the back. In this case, there is a problem that, because of the gap in height between the position of the position indicator 402 and the document tray 403, it is difficult to check by sight the relationship between the position of the position indicator 402 and the position of the end of the documents and thus it is difficult to set documents or a shift after setting of documents occurs.

As for the conventional ADF 400, it is also examined to arrange an indicator on a side wall surface; however, it is necessary to have a display with documents and the indicator making contact in order increase easiness in setting documents and arranging an indicator on the side wall does not solve the problem.

In addition, documents in a standard size are assumed in the conventional ADF 400 and use of the side fences 404 is in general and thus the effect of the shift in the setting position is small. In recent years, however, placing documents in irregular sizes in a mixed manner has been also examined. In such placement in a mixed manner, there is a combination of a large size and a small size and thus positioning with the side fences is ineffective. When a shift in the position in which the documents in different sizes are set occurs, the effect on reading quality, such as skew quality, increases and therefore it is necessary to devise a way to accurately set the position in which documents in different sizes are placed in a mixed manner.

Thus, in the present embodiment, arranging the position indication member 129 indicating the position in which documents are set on the wall surface 128 of the open-close cover 127 makes it possible to accurately recognize the position in which the documents are set even when a view from the front of the ADF 110A to the back in an oblique direction and easily set the center of the documents with respect to the document tray 125. It will be described in detail below.

As illustrated in FIG. 2, in the ADF 110A of the present embodiment, the position indication member 129 is arranged in a position in which the position indication member 129 makes contact with the documents or on the wall surface 128 of the open-close cover near the position of the contact with the documents. In the example illustrated in FIG. 2, because the position indication member 129 is arranged on the wall surface 128 used to align the ends in a direction of conveyance, the ends of the documents and the position indication member 129 make contact with each other.

After the user sets the documents in align with the position indication member 129, the document tray 125 lifts up toward the paper feeding opening 126 and accordingly the documents enter a state of being to be fed and are readable.

The position indication member 129 need not necessarily be arranged in the position in which ends of the documents make contact with the position indication member 129 and the effect is enabled even in the vicinity of the position of contact of the ends of the documents. When the vicinity of the position of contact of the ends of the documents is, for example, within 10 mm with respect to the position of contact of the ends of the documents, it is possible to sufficiently reduce the difference between the position checked by sight and the actual position.

As illustrated in FIG. 2, the setting position indicated by the position indication member 129 is indicated not only in the center but also at given intervals on the left and right in the width direction about a center reference. This enables the user to adjust the position in which both ends of the documents are aligned and perform the setting on the document tray 125 in an appropriate position even when the center of the documents is not clear.

Furthermore, the position indication member 129 makes an indication such that a combination of symmetric positions on the left and right in the width direction about the center reference is graspable. In the example illustrated in FIG. 2, the symmetric positions on the left and right in combination in the width direction about the center reference are presented by the same numbers. Accordingly, by checking whether both ends of documents are in the equivalent positions in combination when setting the documents, the user enables pseudo setting on the center position of the document tray 125.

Arranging the position indication member 129 on the wall surface 128 of the open-close cover 127 as described above makes it possible to directly check by sight the position of setting and the position of documents and thus has an effect of easiness in the setting and of inhibiting a positional shift in the setting. In the present embodiment, using the wall surface 128 of the open-close cover 127 enabling contact of the ends of the documents has an advantage that it is possible to check the display even when a plurality of documents are set. Arranging the position indication member 129 on the document tray 125 is assumable; however, when a large document is placed on the document tray 125, the display cannot be checked for small documents.

Subsequently, an effect of indication of the setting position by the position indication member 129 will be described in detail.

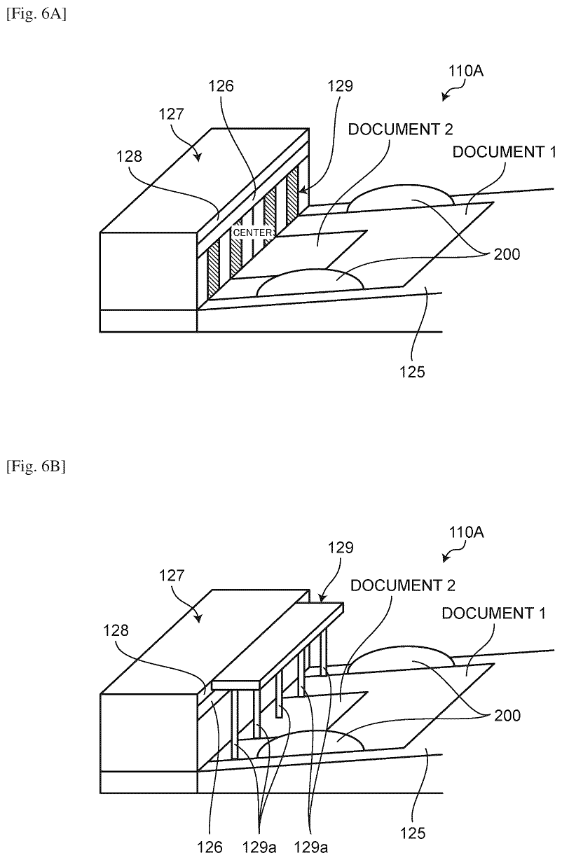

FIGS. 5A and 5B are diagrams illustrating the effect of indication of the setting position by the position indication member. FIGS. 5A and 5b illustrate an example in which the document feeding rollers 121 that are arranged inside the open-close cover 127 are at the center. FIG. 5A illustrates an example in which documents in a plurality of width sizes that are placed in a mixed manner can be placed at the center with respect to the document feeding rollers 121 and FIG. 5B illustrates an example in which documents in a plurality of width sizes that are placed in a mixed manner cannot be placed at the center with respect to the document feeding rollers 121.

As illustrated in FIG. 5A, according to the present embodiment, when documents in a plurality of width sizes placed in a mixed manner are set at a time and are scanned (different width sizes mixed), it is possible to set documents in any width size such that the documents are on the document feeding rollers 121. In the case where documents in a plurality of width sizes placed in a mixed manner are set at a time and are scanned (different width sizes mixed), when there is a shift between the position of the document feeding rollers 121 and a center position of the documents as illustrated in FIG. 5B, a phenomenon that a force in the direction of rotation works and a skew tends to be caused occurs. It is assumed that, with a large skew, the documents reach the outside an area of conveyance and accordingly a damage in the documents is caused and the skew itself has an effect on the image quality, and therefore it is necessary to inhibit a skew. For this reason, when documents in a plurality of width sizes placed in a mixed manner are set at a time and are scanned (different width sizes mixed), it is preferable to perform the setting such that the center position of the documents and the position of the document feeding rollers 121 are aligned.

In other words, according to the present embodiment, making an indication in the position of contact with the documents makes it possible to accurately know the setting position even when viewing in an oblique direction, which easily enables the user to accurately set documents in a plurality of width sizes placed in a mixed manner and enables printing quality to increase.

According to the present embodiment, even when the side fences 200 are being free, it is possible to indicate a position in which documents are set and that tends not to cause a skew.

In the present embodiment, the position indication member 129 is described as being printed on the wall surface of the open-close cover 127 or being a sheet in a form of a sticker and being adhered; however, the position indication member 129 is not limited to this. A modification will be described below.

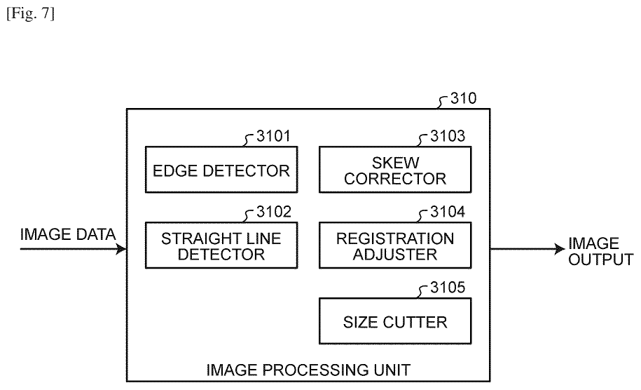

FIGS. 6A and 6B are diagrams illustrating the modification of the position indication member 129. In the example illustrated in FIG. 2, the symmetric positions on the left and right in combination in the width direction about the center reference are presented by the same numbers in the position indication member 129; however, as illustrated in FIG. 6A, the color pattern of the areas of the symmetric positions on the left and right in combination in the width direction about the center reference may be changed and represented in the position indication member 129. Compared to numerical values or symbols, such as characters, color has high noticeability because it is only needed to see whether the ends of the documents are in areas in the same color on the left and right. Note that the position indication member 129 may indicate a combination of symmetric positions on the left and right in the width direction about the center reference in a combination of a color and a symbol.

As illustrated in FIG. 6B, it is also assumable that the position indication member 129 has a configuration in which string members 129a, such as strings or tapes, hang in a form like a split curtain from the wall surface 128 having the paper feeding opening 126 of the open-close cover 127 to indicate the positions.

### Second Embodiment

A second embodiment will be described next.

The second embodiment is different from the first embodiment in providing an image in the same size as a document to a user. In description of the second embodiment, description of the same part as that in the first embodiment is omitted and parts different from the first embodiment will be described below.

As described above, it is possible to indicate a position in which documents are set and that tends not to cause a skew even when the side fences 200 are being free. While the possibility that a large skew would occur reduces accordingly, a skew is not completely reduced. In scanning documents in a plurality of types of width sizes with an aim of keeping the side fences 200 free, a document in an irregular size can also be input and thus the accurate size is not clear at the time of reading and it is not possible to provide an image in the same size as the document to the user.

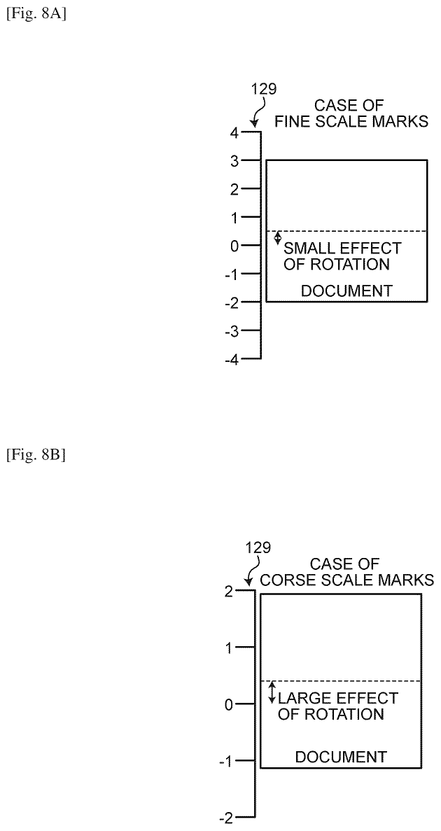

FIG. 7 is a block diagram illustrating a functional configuration of the image processing unit 310 that the image forming apparatus 100 according to the second embodiment includes. As illustrated in FIG. 7, the image processing unit 310 includes an edge detector 3101, a straight line detector 3102, a skew corrector 3103, a registration adjuster 3104, and a size cutter 3105.

The edge detector 3101 detects an edge from an image based on image data that is input. An edge detection method taken by the edge detector 3101 may be any method, for example, detection of a difference in concentration between an area of the background and an area of a document or detection of a shade formed at the boundary between the background area and the document area.

The straight line detector 3102 detects straight lines that are respective sides from the result of edge detection performed by the edge detector 3101.

The skew detector 3103 executes a skew correction according to edge information that is detected by the edge detector 3101 and the straight lines that are detected by the straight line detector 3102.

The registration adjuster 3104 executes an adjustment on a position of registration. A registration adjustment method performed by the registration adjuster 3104 may be any method, such as detecting and correcting intersections of straight lines that are the respective sides and that are detected by the straight line detector 3102.

The size cutter 3105 performs cutting out with the document size from the result of edge detection performed by the edge detector 3101. A method of cutting out with the size performed by the size cutter 3105 may be any method, such as detecting a width between the top and bottom sides and a width between the left and right sides from the result of edge detection performed by the edge detector 3101, detecting a size, and making a correction.

It is accordingly possible to provide an image in the same size as the document to the user and thus, when documents in a plurality of width sizes that are placed in a mixed manner are set at a time and are scanned (different width sizes mixed), it is possible to not only improve the quality using the setting position but also further improve the quality by combination with correction in image processing in the image processing unit 310.

Widths between scale marks in the position indication member 129 will be described next.

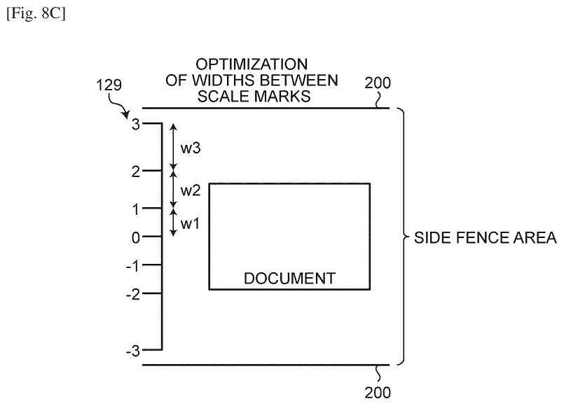

FIGS. 8A to 8C are diagrams illustrating a relationship between widths between scale marks and a skew in the position indication member 129. The widths between scale marks in the position indication member 129 has an effect on easiness in setting at the time when the user sets documents. For example, in the case where the widths between scale marks in the position indication member 129 is small as illustrated in FIG. 8A, when the documents are set such that the documents cover the same numerals on the left and right, the positioning accuracy required to the user is fine and time is required for adjustment.

On the other hand, in the case where the widths between scale marks in the position indication member 129 is large as illustrated in FIG. 8B, when documents are set such that the documents cover the same numerals on the left and right, the user is able to set the documents more easily.

When a shift from the center is large at the time when the documents are set, a conveyance barycentric position and a document barycentric position shift and accordingly a skew at the time of conveyance tends to occur. For example, as illustrated in FIG. 8A and FIG. 8B, the effect of rotation reduces in the case where the widths between scale marks are small and the effect of rotation increases in the case where the widths between scale marks are large. In other words, tendency of occurrence a skew varies depending on the size of the widths between scale marks in the position indication member 129.

For this reason, it is preferable to determine widths between scale marks in con-sideration of the amount of skew that is permissible by the skew corrector of the image processing unit 310 as described above.

In the example illustrated in FIG. 8C, a configuration enabling both accuracy and usability using the widths between scale marks in the position indication member 129 will be described.

The ADF 110A has a determined maximum size width (for example, an A3 size width) and there are regulating members (the side fences 200) in the width direction.

As for a document in a large size, the side fences 200 reduce an angle of skew and, even when the setting position somewhat shifts in the width direction, the effect is small. As described above, because the interval of the widths between scale marks in the position indication member 129 has an effect on usability, it is desirable that the interval be set as wide as possible.

The example illustrated in FIG. 8C represents an example in which the widths between scale marks in the position indication member 129 are varied such that the widths between scale marks increase with distance from the center in the width direction. More specifically, as illustrated in FIG. 8C, the widths between scale marks in the position indication member 129 are set smaller towards the center (w1<w2<w3).

Accordingly, it is possible to simplify adjustment on the setting position while making an indication such that the effect of the setting position on a skew can be reduced as much as possible.

Each of the above-described embodiments is described taking the example in which the image forming apparatus of the present invention is applied to a multifunction peripheral having at least two of the copy function, the printer function, the scanner function, and the facsimile function, and the image forming apparatus is applicable to any image forming apparatus, such as a copier, a printer, a scanner device, or a facsimile device.

The embodiments of the present invention have been described and each of the embodiments is presented as an example and does not intend to limit the scope of the invention. These new embodiments can be carried out in other various modes and various omissions, replacements and changes can be made within a range without departing from the subject matter of the invention. Each of these embodiments is included in the scope and the subject matter of the invention and is included in the invention described in the claims and the scope of the equivalents of the invention.

### REFERENCE SIGNS LIST

100 Image forming apparatus
105 Image forming unit
110 Image reading device
110B Image reading unit
121 Conveyance unit
125 Document tray
128 Wall surface
129 Position indication member
129a String member
310 Image processing unit

### CITATION LIST

### Patent Literature

PTL 1: Japanese Laid-open Patent Publication No. H10-063044

1. An image reading device comprising:
a document tray having a document placement surface on which one or more documents are placed;
a conveyor configured to convey the documents one by one;
an image reader configured to read images of the documents conveyed by the conveyor and
a position indication member indicating a position in which the documents should be placed with respect to the document tray,
wherein the position indication member makes indication in a position of contact with the documents or near the position of contact with the documents.

2. An image reading device comprising:
a document tray having a document placement surface on which one or more documents are placed;
a wall surface on which the documents placed on the document tray are made to abut;
a conveyor configured to convey the documents one by one;
an image reader configured to read images of the documents conveyed by the conveyor; and
a position indication member arranged on the wall surface and having scale marks indicating a position in which the documents are to be set on the document placement surface.

3. The image reading device according to claim 2, wherein the position indication member has the scale marks indicating positions at predetermined intervals on left and right in a width direction of the document about a center reference.

4. The image reading device according to claim 2, wherein the position indication member has the scale marks with which a combination of symmetric positions on left and right in a width direction of the document about a center reference is graspable.

5. The image reading device according to claim 4, wherein the position indication member indicates the combination of the symmetric positions on left and right in the width direction of the document about the center reference using at least any one of a symbol or a color.

6. The image reading device according to claim 4, wherein the position indication member has widths between the scale marks varying with distance from the center reference in the width direction of the document.

7. The image reading device according to claim 4, wherein the position indication member has widths between the scale marks varying such that the widths between scale marks increase with distance from the center reference in the width direction of the document.

8. The image reading device according to claim 2, comprising an image processor configured to perform any one of a process of detecting an edge from an image obtained by reading a document, a process of performing a skew correction based on information on the detected edge, a process of adjusting a registration position based on the information on the detected edge, and a process of cutting out with a document size based on the information on the detected edge.

9. The image reading device according to claim 2, wherein the position indication member is attached to the wall surface as a sheet in a form of a sticker.

10. The image reading device according to claim 2, wherein the position indication member has string members hanging from the wall surface.

11. An image forming apparatus comprising:
the image reading device according to claim 1; and
an image former.
